(19) United States
(12) Patent Application Publication
(10) Pub. No.: US 2025/0358194 A1
(43) Pub. Date: Nov. 20, 2025

(54) TECHNIQUES FOR ENHANCED CONGESTION CONTROL USING NETWORK FEEDBACK SIMULATION

(71) Applicant: Ottopia Technologies Ltd., Tel Aviv (IL)

(72) Inventors: Ravid COHEN, Nataf (IL); Alexander KIRSHON, Netanya (IL)

(73) Assignee: Ottopia Technologies Ltd., Tel Aviv (IL)

(21) Appl. No.: 18/664,769

(22) Filed: May 15, 2024

(51) Int. Cl. H04L 41/14; H04L 41/16; H04L 43/55

(52) U.S. Cl. CPC H04L 41/145; H04L 41/16; H04L 43/55

(57) ABSTRACT

A system and method for network feedback simulation injection. A method includes simulating network feedback for one or more communication channels used by a system and injecting the simulated network feedback into one or more decision-making processes. The simulated network feedback includes one or more simulated network parameters indicating values of corresponding network performance metrics. The decision-making processes are configured to make system decisions based on network feedback data.

### TECHNICAL FIELD

The present disclosure relates generally to remote operation, and more specifically to improving remote operation using simulated network feedback.

### BACKGROUND

With modern networking technology, more and more solutions are being offered to remotely control or otherwise operate systems. These remote operation systems are configured to perform at least some of their operations based on instructions received from a remote system. Remote operation can be utilized to realize benefits such as convenient operation by another, takeover in cases of operator failure, compensating for malfunctioning components, providing access to capabilities which are not inherent to local systems, and much more.

An example of a technology which may be aided via remote operation capabilities is vehicle operation. For example, performing at least some of the vehicle's operations remotely may allow for taking over driving when the driver in the vehicle is incapacitated or when the difficulty of driving in a given area exceeds a driver's capabilities. Thus, the ability to control vehicle operations remotely in certain circumstances may improve overall operation of the vehicle.

While remote operation can provide many benefits, successful remote operation requires network connections. Drops in network connectivity may negatively affect remote operation and, in particular, may affect receiving data used to ensure appropriate remote operation. Additionally, some systems may have greater network capabilities than others. Solutions which can mitigate network connectivity issues and overcome network capability limitations would therefore aid in improving remote operation.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for network feedback simulation injection. The method comprises: simulating network feedback for at least one communication channel used by a system, wherein the simulated network feedback includes at least one simulated network parameter, each simulated network parameter indicating at least one value of a corresponding network performance metric; and injecting the simulated network feedback into at least one decision-making process, wherein each decision-making process is configured to determine decisions for the system based on network feedback data.

Certain embodiments disclosed herein also include a non-transitory computer readable medium having stored thereon causing a processing circuitry to execute a process, the process comprising: simulating network feedback for at least one communication channel used by a system, wherein the simulated network feedback includes at least one simulated network parameter, each simulated network parameter indicating at least one value of a corresponding network performance metric; and injecting the simulated network feedback into at least one decision-making process, wherein each decision-making process is configured to determine decisions for the system based on network feedback data.

Certain embodiments disclosed herein also include a system for network feedback simulation injection. The system comprises: a processing circuitry; and a memory, the memory containing instructions that, when executed by the processing circuitry, configure the system to: simulate network feedback for at least one communication channel used by a system, wherein the simulated network feedback includes at least one simulated network parameter, each simulated network parameter indicating at least one value of a corresponding network performance metric; and inject the simulated network feedback into at least one decision-making process, wherein each decision-making process is configured to determine decisions for the system based on network feedback data.

Certain embodiments disclosed herein include the method, non-transitory computer readable medium, or system noted above, wherein the system is a first system, wherein the simulated network feedback is based on a simulation of network performance for network communications between the first system and a second system.

Certain embodiments disclosed herein include the method, non-transitory computer readable medium, or system noted above, further including or being configured to perform the following step or steps: detecting a simulation trigger including transmission of data from the first system to the second system, wherein the simulation is initiated when the simulation trigger is detected.

Certain embodiments disclosed herein include the method, non-transitory computer readable medium, or system noted above, wherein the simulated network feedback is a first set of network feedback, wherein the first system receives a second set of network feedback from the second system, wherein the first set of network feedback is utilized by the at least one decision-making process until the second set of network feedback is received by the first system.

Certain embodiments disclosed herein include the method, non-transitory computer readable medium, or system noted above, further including or being configured to perform the following step or steps: injecting the second set of network feedback into the at least one decision-making process.

Certain embodiments disclosed herein include the method, non-transitory computer readable medium, or system noted above, further including or being configured to perform the following step or steps: detecting a simulation trigger based on passage of a predetermined amount of time since a most recent receipt of network feedback, wherein the simulation is initiated when the simulation trigger is detected.

Certain embodiments disclosed herein include the method, non-transitory computer readable medium, or system noted above, wherein the simulated network feedback further includes simulated content of the simulated network feedback.

Certain embodiments disclosed herein include the method, non-transitory computer readable medium, or system noted above, wherein the simulated network feedback further includes a simulated timing for the simulated network feedback.

Certain embodiments disclosed herein include the method, non-transitory computer readable medium, or system noted above, wherein the at least one simulated network parameter is at least a portion of at least one network feedback aspect to be simulated, further including or being configured to perform the following step or steps: determining the at least one network feedback aspect to be simulated based on historical network feedback, wherein the at least one simulated network parameter is at least one type of network parameter which is represented in the historical network feedback.

Certain embodiments disclosed herein include the method, non-transitory computer readable medium, or system noted above, further including or being configured to perform the following step or steps: determining the at least one network feedback aspect to be simulated based further on a decision-making process type for each of the at least one decision-making process.

Certain embodiments disclosed herein include the method, non-transitory computer readable medium, or system noted above, further including or being configured to perform the following step or steps: establishing at least one simulation parameter based on the determined at least one network feedback aspect to be simulated, wherein establishing the at least one simulation parameter further comprises applying a simulation establishment machine learning model to features extracted from data transmitted by the system.

Certain embodiments disclosed herein include the method, non-transitory computer readable medium, or system noted above, further including or being configured to perform the following step or steps: applying at least one simulator machine learning model to the established at least one simulation parameter, wherein the simulated network feedback is based further on outputs of the at least one simulator machine learning model.

Certain embodiments disclosed herein include the method, non-transitory computer readable medium, or system noted above, wherein the at least one communication channel is a plurality of communication channels, further including or being configured to perform the following step or steps: running a simulation for each of the plurality of communication channels, wherein the simulated network feedback is based on simulation results for the simulation of each of the plurality of communication channels.

Certain embodiments disclosed herein include the method, non-transitory computer readable medium, or system noted above, wherein the at least one simulated network parameter includes at least one of latency, jitter, and packet loss.

Certain embodiments disclosed herein include the method, non-transitory computer readable medium, or system noted above, further including or being configured to perform the following step or steps: determining, using the at least one decision-making process, the decisions for the system based on the simulated network feedback; and controlling the system based on the determined decisions.

Certain embodiments disclosed herein include the method, non-transitory computer readable medium, or system noted above, wherein the system is a vehicle, wherein the determined decisions include driving decisions for the vehicle, wherein controlling the system further comprises driving the vehicle based on the driving decisions.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIGS. 1A-D are network diagrams utilized to describe various disclosed embodiments.

FIGS. 2A-B are network feedback diagrams utilized to describe various disclosed embodiments.

FIG. 3 is a flowchart illustrating a method for making remote operation decisions using simulation injection according to an embodiment.

FIG. 4 is a flowchart illustrating a method for simulating network feedback according to an embodiment.

FIG. 5 is a flowchart illustrating a method for operating a vehicle based on simulated network feedback according to an embodiment.

FIG. 6 is a schematic diagram of a simulation injector according to an embodiment.

### DETAILED DESCRIPTION

The various disclosed embodiments include techniques for remote operation using simulated network feedback. More specifically, the disclosed embodiments include various techniques which inject results of network feedback simulations into a decision-making process in order to improve remote operation with respect to the decision-making process. To this end, the disclosed embodiments provide techniques for simulating network feedback and for injecting the simulation results into other processes. In accordance with various disclosed embodiments, the simulation results include simulated network feedback parameters, and are injected into processes which are configured to make decisions at least partially based on network feedback parameters such that decisions made by those processes are made based on the simulated network feedback parameters.

In accordance with at least some disclosed embodiments, network feedback is simulated for one or more communication channels. Each communication channel, which may also be referred to as a channel, is a connection in the form of a physical transmission medium or a logical connection used to transmit at least data in the form of packets over one or more networks. Each channel represents a connection to a network via a respective network interface. As a non-limiting example, one of the channels may be a connection to the Internet as the network realized via a modem acting as the network interface. That is, for each channel (and, therefore, for each network connection or potential network connection), feedback for the network connection of that channel may be simulated in order to obtain a set of simulated network parameters. The simulated network parameters are injected into a decision-making process and utilized to determine decisions as described herein.

The network feedback, which may also be referred to herein as “feedback,” includes network parameters representing network performance of a sending system and, in particular, of a network connection used by the sending system to transmit data (e.g., in the form of packets). To this end, such network parameters may include, but are not limited to, latency, jitter, packet loss, combinations thereof, and the like. That is the feedback network parameters represent performance of a network connection with respect to outputs of the sending system transmitted via the network connection. Such network parameters may be determined by a receiving system and included in data transmitted by the receiving system back to the sending system as a response to the data transmitted by the sending system.

Such feedback may be utilized by the sending system in order to make decisions about actions to perform such as, but not limited to, driving decisions. Accordingly, failing to receive the feedback timely may result in the sending system failing to make decisions timely, to make decisions accurately, or both. By simulating network feedback and injecting the simulation results into one or more decision-making processes used by the sending system, such processes can make faster and more accurate decisions during the time period when feedback has not yet been received. Moreover, when actual feedback is received from the receiving system, the actual feedback may be injected into the decision-making processes such that the decision-making processes begin using the actual feedback in addition to or instead of the simulated feedback, thereby further improving accuracy of decisions once the actual feedback has been received.

In some embodiments, the simulation results may further include other parameters such as, but not limited to, simulated content of responses to data transmitted by the sending system, simulated meta information about feedback (e.g., a simulated timing value indicating an expected time for the feedback), both, and the like. Such additional simulated data may allow for further improving the accuracy of decision-making while awaiting actual feedback.

Injecting network feedback simulation results as described herein may provide various benefits. In particular, simulated network feedback parameters may be utilized instead of actual network feedback parameters until the actual network feedback parameters are received, thereby allowing for making more accurate decisions in the meantime. Moreover, simulated network feedback parameters may be generated via simulation and injected into decision-making processes more quickly than actual feedback can be received in at least some circumstances such that response times for decisions made in response to simulated network feedback are shorter than the theoretical minimum for response times of responses to actual network feedback given a current set of network conditions. Accordingly, the disclosed embodiments may allow for significantly improving performance of decision-making processes which utilize network feedback as compared to at least some existing solutions.

Further, the disclosed embodiments may improve decision-making for processes utilizing network feedback when network conditions degrade. Such degradation of network conditions may cause feedback to not be received or to be received much later, which would otherwise affect the ability of the decision-making process to accurately determine decisions such as, but not limited to, decisions for operating a target system. Using simulated network feedback may compensate for the lack or delay of actual feedback when network conditions degrade, thereby improving decision-making over time as network conditions vary. This effect may be further pronounced when the decision-making process is executed by a moving system such as a system installed on a vehicle, which may cause further fluctuations in network conditions vis-à-vis the system.

Additionally, the disclosed embodiments may be used to compensate for deficiencies in network capabilities of systems. That is, using simulated network feedback may improve performance of decision-making processes executed via systems with lesser network capabilities such as, but not limited to, a lower number of potential links for network communications. Such lesser network capabilities may cause issues such as failure to receive network feedback timely or at all, thereby improving performance of the decision-making processes. Using simulated network feedback as described herein may therefore compensate for drawbacks caused by lesser network capabilities.

As a non-limiting example for how the disclosed embodiments may compensate for lesser network capabilities, when fewer network links are available such that there is less of a failsafe than a system with a desired set of network links, response times may be decreased in order to compensate and ensure safe operation of the vehicle according to existing solutions. Using simulated network feedback as described herein may compensate for the lower amount of links, thereby allowing for safe operation of the vehicle without decreasing response times (or by decreasing response times less than would be performed when using existing solutions in order to achieve a comparable level of safety).

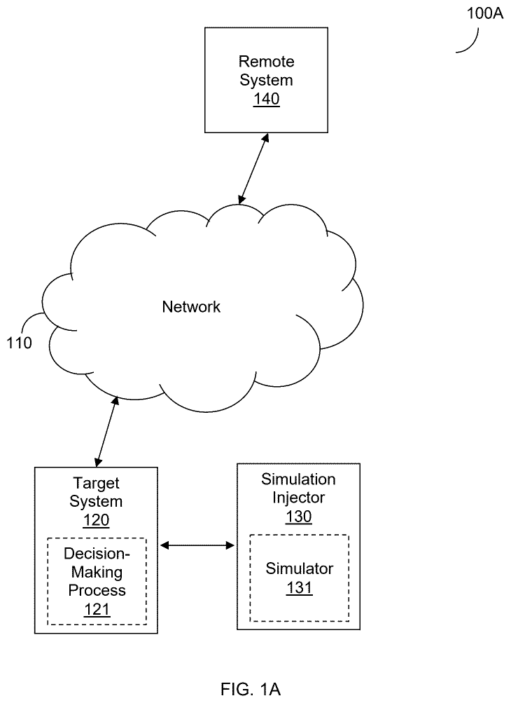

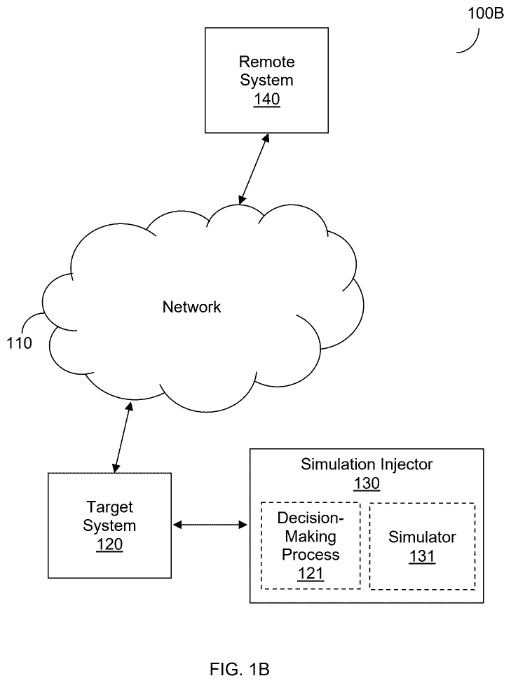

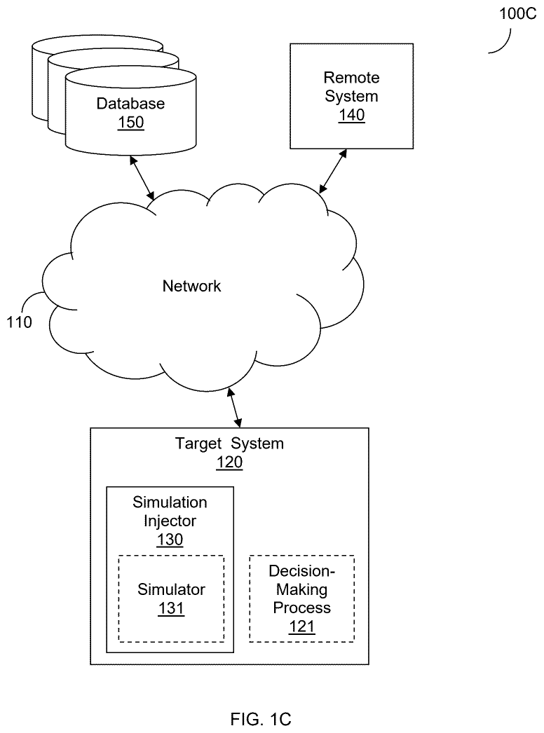

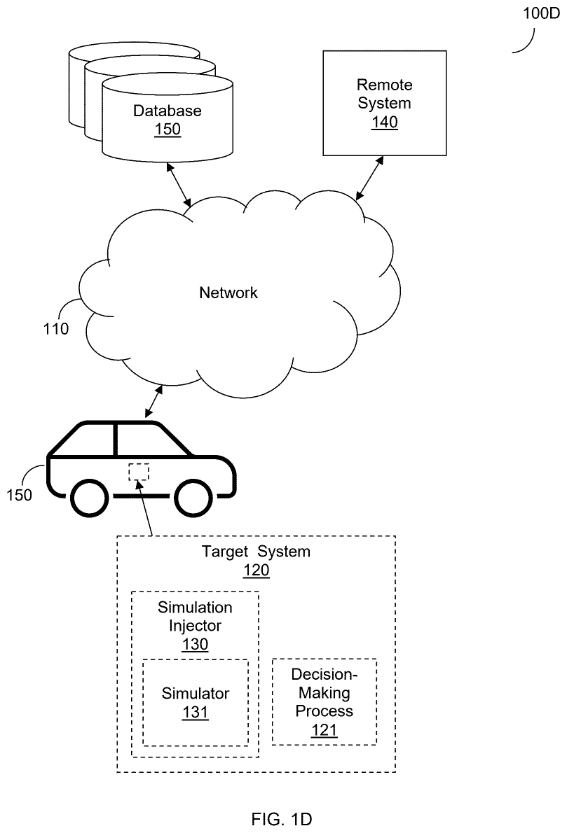

FIGS. 1A-D show example network diagrams 100A through 100D, respectively, utilized to describe the various disclosed embodiments. In the example network diagram 100A, a target system 120 and a remote system 140 communicate via a network 110. Also depicted in FIG. 1A, a simulation injector 130 is deployed such that it is communicatively connected to the target system 120.

The network 110 may be, but is not limited to, a wireless, cellular or wired network, a local area network (LAN), a wide area network (WAN), a metro area network (MAN), the Internet, the worldwide web (WWW), similar networks, and any combination thereof.

The target system 120 is a system which is at least partially operated based on decisions made by the simulation injector 130. Non-limiting examples for types of systems which may act as the target system 120 include vehicles or vehicle control systems, robots, industrial machine control systems, surgical systems, and the like. The target system 120 is configured to at least partially operate based on remote commands or otherwise data received from a remote system such as the remote system 140. As discussed herein, such remote operation relies upon network communications (e.g., via the network 110) and, as a result, such remote operation may be improved using simulated network feedback in accordance with one or more disclosed embodiments.

In accordance with at least some implementations, the target system 120 runs a decision-making process 121. The decision-making process 121 may be realized via a set of instructions that, when executed by a processing circuitry, configure the processing circuitry to determine decisions for actions to be performed by the target system 120 based on network feedback. That is, the decision-making process 121 may be realized via execution of such instructions in order to initiate an instance of the decision-making process 121. As discussed herein, at least some of the network feedback used by the decision-making process 121 includes simulated network feedback generated by the simulation injector 130 (e.g., via a simulator 131).

The decision-making process 121 is configured to determine one or more decisions for operating the target system 120. As a non-limiting example where the target system 120 is a vehicle (e.g., as visually depicted in FIG. 1C), such decisions may be or may include driving decisions or decisions to deploy safety mechanisms. More specifically, in accordance with various disclosed embodiments, the decision-making process 121 is configured to determine such decisions based on network feedback data. Such network feedback data may be or may include network parameters such as, but not limited to, jitter, latency, packet loss, combinations thereof, and the like.

The simulation injector 130 is configured to simulate network feedback between the target system 120 and the remote system 140. More specifically, the simulation injector 130 may be configured to simulate network feedback for data transmitted by the target system 120 acting as a sending system. To this end, such simulated feedback may represent expected or otherwise estimated feedback from the remote system 140 acting as a receiving system.

During normal operation, such feedback may be received in forms such as network parameters (e.g., latency, jitter, packet loss, etc.) indicating network performance of a network connection (not shown) used to communicate between the target system 120 and the remote system 140. The feedback may be included among data transmitted by the remote system 140 to the target system 120, for example, in response to data previously transmitted by the target system 120 to the remote system 140. When network communications are subject to interference, such feedback may be delayed or may not be received at all. In accordance with various disclosed embodiments simulation injector 130 may utilize simulated feedback until actual feedback is received from the remote system 140 (e.g., during a time period since the last feedback was received from the remote system 140).

In accordance with at least some implementations, the simulation injector 130 may be configured with logical components such as, but not limited to, a simulator 131. The simulator 131 may be realized as a set of instructions that, when executed by a processing circuitry, configure the processing circuitry to simulate network feedback and to inject simulation results (e.g., in the form of one or more simulated network feedback parameters or other simulated network feedback data) into the decision-making process 121 as described herein.

In accordance with various disclosed embodiments, the simulator 131 injects simulated network feedback data into the decision-making process 121 in order to provide network feedback data to be utilized by the decision-making process 121, for example, while awaiting actual network feedback from the remote system 140. That is, decisions by the decision-making process 121 may be determined based on simulated network feedback data injected by the simulator 131.

As discussed herein, using the simulated network feedback data may allow for beginning making decisions earlier and more accurately than solutions which only utilize actual simulation data, particularly in situations where the actual simulation data arrives later than expected or does not arrive at all. Moreover, using simulated network feedback data that is generated locally may allow for beginning to make decisions based on the simulated network feedback data faster than the theoretical minimum amount of time it would take to receive a response from the remote system 140 including the actual feedback data. As a result, the disclosed embodiments may further improve accuracy of decision-making even in situations where the actual feedback data is received on time (i.e., at an expected time).

FIG. 1B is an illustration 100B of an alternative implementation in which the decision-making process 121 is realized as one or more hardware or logical components of the simulation injector 130. In such an implementation, the simulation injector 130 injects simulation results generated by the simulator 131 into the decision-making process 121, and decisions made by the decision-making process 121 may be transmitted to the target system 120 to be utilized for performing actions by the target system 120.

FIG. 1C is an illustration 100C of an implementation in which the simulation injector 130 is deployed as a subcomponent of the target system 120. In such an implementation, the simulation injector 130 may be a physical or logical subcomponent of the target system 120.

Additionally, it should be noted that the simulator 131 and the decision-making process 121 are depicted as separate logical components in FIGS. 1A-D for example purposes, but that at least some disclosed embodiments are not limited as such. In some embodiments, the simulator 131 and the decision-making process 121 may be realized as a single program or otherwise as a single set of instructions. In such embodiments, injecting the simulation results may include passing parameters or other data as values to the portions of instructions among the program used to realize the decision-making process.

FIG. 1D is an illustration 100D of an implementation 100D in which the target system 120 is deployed in a vehicle 150. As illustrated in FIG. 1D, the target system 120 is realized as a logical component of the vehicle 150. In other implementations (not shown), the target system 120 may be realized as a hardware component deployed in the vehicle 150. In the implementation depicted in FIG. 1D, the target system 120 includes the simulation injector 130 and the runs the decision-making process 121. The simulation injector 130, in turn, runs the simulator 131 and injects simulation results from the simulator 131 into the decision-making process 121.

As noted above, various disclosed embodiments may be suitable for aiding in making driving decisions via a decision-making process such as the decision-making process 121, thereby improving remote driving or other remote vehicle operation performance and improving safety of the vehicle in which the target system 120 is deployed.

It should be noted that the simulator 131 and the decision-making process 121 are not depicted in FIG. 1C merely for simplicity purposes, but that the simulation injector 130 may include such simulator 131 and decision-making process 121 as logical components in accordance with the embodiments discussed with respect to FIG. 1C.

It should also be noted that a single instance of a simulator 131 and a decision-making process 121 are depicted in FIGS. 1A-D for simplicity purposes, but that multiple instances of the simulator 131, the decision-making process 121, or both, may be utilized in accordance with various disclosed embodiments. As a non-limiting example, different instances of the simulator 131 may be utilized to simulate network feedback for different respective communication channels.

Moreover, in implementations using multiple decision-making processes, the decision-making processes may be organized into tiers. Such tiers may allow, for example, injecting simulation results for different channels into multiple decision-making processes associated with a given channel or otherwise injecting sets of simulation results across different decision-making processes within respective tiers (i.e., tiers corresponding to certain types of simulated data).

As another non-limiting example, different instances of the decision-making process 121 may be utilized to determine different types of decisions (e.g., decisions for different activities) or to determine decisions for different channels. In such an example, each instance of the decision-making process 121 may utilize at least a portion of network feedback and simulated network feedback (e.g., network feedback and simulated network feedback for respective channels among at least a portion of channels used by the target system 120, data indicating at least a portion of the aspects of network feedback being simulated, etc.), where the at least a portion of network feedback and simulated network feedback for different instances of the decision-making process 121 may be different. As a non-limiting example, a first instance of the decision-making process 121 may utilize a first portion of aspects of the simulated network feedback, and a second instance of the decision-making process 121 may utilize a second portion of aspects of the simulated network feedback, where the first and second portions of the simulated network feedback include at least some non-overlapping aspects (i.e., at least some aspects of simulated network feedback among the first portion are not present in the second portion, or vice versa).

Additionally, it should be noted that a single remote system 140 is depicted in FIGS. 1A-D for simplicity, but that the disclosed embodiments may be equally applied to communications between the target system 120 and multiple remote systems (not shown). As a non-limiting example, different instances of the decision-making process 121 may be utilized to determine decisions with respect to a corresponding remote system, and the channels whose simulation results are utilized for each instance of the decision-making process 121 may include each channel used to communicate between the target system 120 and the corresponding remote system among the multiple remote systems.

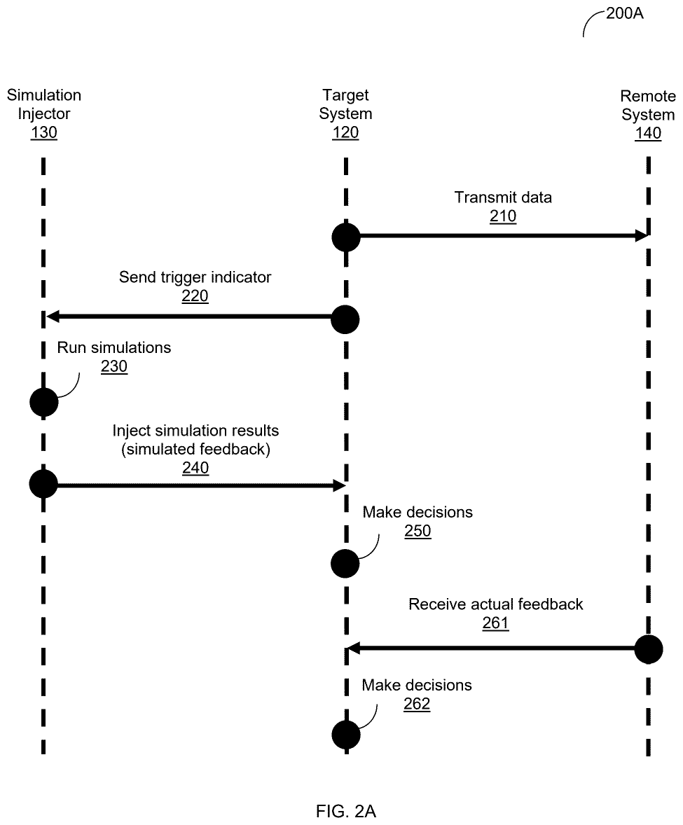

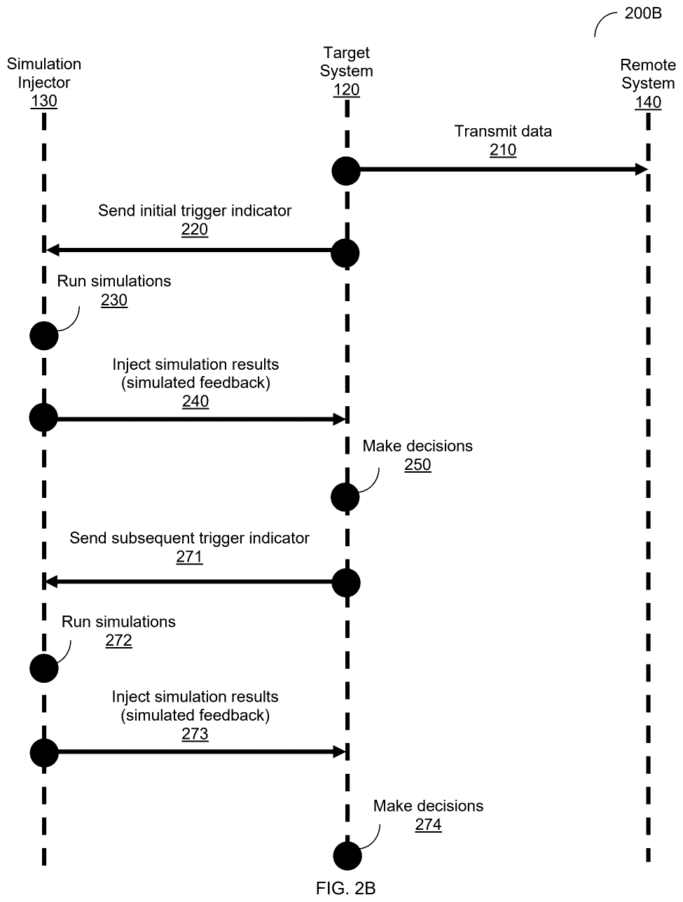

FIGS. 2A-B are network feedback diagrams 200A and 200B, respectively, utilized to describe various disclosed embodiments.

Communications between and among the target system 120, the simulation injector 130, and the remote system 140 are depicted in FIG. 2A. As depicted in FIG. 2A, the target system 120 transmits data 210 to the remote system 140. The transmitted data includes data for which a response from the remote system 140 is expected and, more specifically, for which a response including network feedback is expected.

When the data is transmitted at 210, the target system 120 also sends a trigger indicator 220 to the simulation injector 130. The trigger indicator sent at 220 may indicate the transmission of data at 210 as a trigger for running simulations and injecting simulation results. It should be noted that the sending of the trigger indicator 220 is depicted as occurring after the transmission of data 210 for simplicity, but that these events may occur in parallel without departing from the scope of the disclosure. That is, the target system 120 may both transmit data 210 to the remote system 140 and send the trigger indicator 220 to the simulation injector 130 simultaneously or otherwise in parallel.

In some embodiments, the trigger indicator sent at 220 may be sent alongside other data to be used for running simulations. Such data may include, but is not limited to, copies of the data transmitted at 210 or other data indicating certain information regarding the data transmitted at 210 which are to be used for running simulations. As a non-limiting example, data indicating a use case for which the data was transmitted at 210 such as operating a vehicle may be sent along with the trigger indicator at 220.

In response to the trigger indicator sent at 220, one or more simulations are run 230. The simulations may be run at 230 using sets of simulation parameters as described further below. Results of the simulations run at 230 may include, but are not limited to, simulated network parameters. These simulated network parameters may have corresponding values representing values of respective key performance indicators (KPIs) or other network performance metrics used to measure network performance and which may be utilized in decision-making by the target system 120.

The simulation results which are outputs of the simulations run at 230 or based on such outputs are injected as simulated feedback at 240. More specifically, the simulation results are injected 240 to a decision-making process (not shown in FIGS. 2A-B) run by the target system 120.

Based on the injected simulation results acting as simulated feedback, one or more decisions may be made by the target system 120. Such decisions may include, but are not limited to, decisions on operational actions to be performed by the target system 120. Non-limiting examples for such decisions may include driving decisions for a vehicle, decisions on movement or actions to be performed by a robot, and the like.

Decisions may continue to be made 250 based on injected simulation results 240 unless and until actual feedback is received 261. To this end, such actual feedback may be sent by the remote system 140 to the target system 120. When the actual feedback is received 261, additional decisions 262 may be made using the actual feedback.

FIG. 2B depicts a scenario in which no actual feedback is received (e.g., as discussed above with respect to 261). As depicted in FIG. 2B, the flow of communications may proceed as described above with respect to FIG. 2A until decisions are made at 250. In the implementation shown in FIG. 2B, after decisions are made 250 based on simulated feedback, a subsequent trigger indicator may be sent 271 from the target device 120 to the simulation injector 130. The subsequent trigger indicator may indicate, for example, that no feedback was received within a threshold period of time since the initial data transmission or that subsequent data for which feedback is expected has been transmitted (not shown).

Based on the subsequent trigger indicator sent at 271, additional simulations are run 272. The simulation results for the additional simulations are injected into the decision-making process used by the target system 120 at 273, and the decision-making process makes decisions for the target system at 274.

It should be noted that each of FIG. 2A and FIG. 2B depicts a single iteration for simplicity purposes, but that multiple iterations (not depicted) may be equally utilized in accordance with various disclosed embodiments.

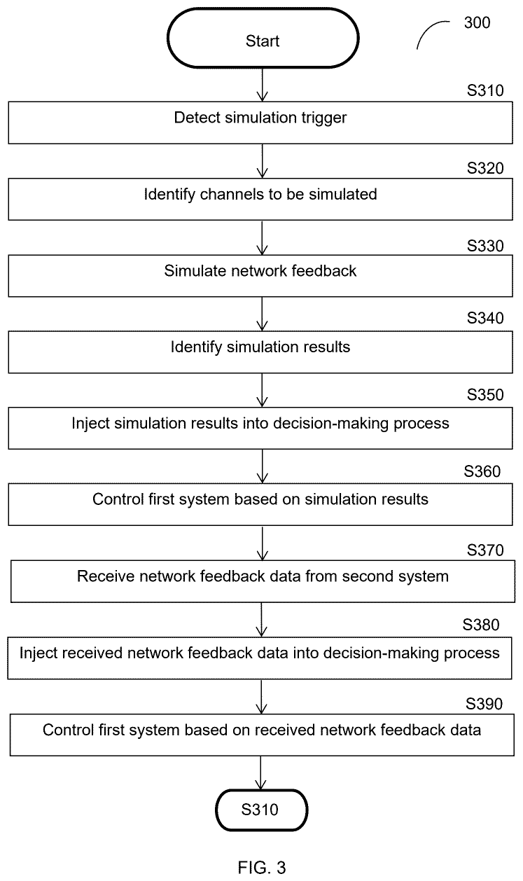

FIG. 3 is a flowchart 300 illustrating a method for making remote operation decisions using simulation injection according to an embodiment. In an embodiment, the method is performed by the simulation injector 130, FIGS. 1A-D.

At S310, a simulation trigger is detected. The simulation trigger may be or may include, but is not limited to, transmission of data for which feedback is expected. In some implementations, execution begins when a system begins transmitting data and continues through iterations as long as the system continues transmitting data. At each iteration, the simulation trigger may be the transmission of data over a channel, or the passage of a certain amount of time (e.g., a predetermined amount of time) since a last transmission of data over the channel or since a most recent receipt of actual (i.e., non-simulated) network feedback from another system.

In some embodiments, transmission of data over different channels may act as the simulation trigger for different instances of the process of FIG. 3. In such an embodiment, different instances of the process may be performed in series or in parallel, with each instance including simulation of network feedback for a respective channel and injection of the simulation results for that channel into a decision-making process (e.g., the decision-making process 121) as feedback for that channel. In a further embodiment, the simulation triggers may be detected for respective channels and be utilized to trigger instances of the process of FIG. 3 for each channel.

In another embodiment, one instance of the process of FIG. 3 may be initially triggered by an initial simulation trigger (e.g., sending of data over one of the channels), and simulations for multiple channels may be performed. That is, when a simulation trigger is detected for any of the channels to trigger a first instance of the process, the process may include simulating network feedback for multiple channels and injecting network feedback simulation results for each of those channels to a decision-making process. Subsequent simulation triggers may include, for example, passage of time. For example, after the initial simulation trigger, iterations of the process including simulating network feedback for the different network channels may be performed periodically, with each iteration being initiated after a certain amount of time has passed.

At S320, network connections for which simulations are to be performed are identified. The network connections may be or may include network connections used by a system (e.g., the target system 120) to transmit data and, more specifically, network connections for which the system would receive feedback from another system to which the data is transmitted (e.g., the remote system 140) during normal operation.

In an embodiment, each network connection may be utilized to transmit data over a corresponding communication channel (also referred to as a “channel”). In a further embodiment, each channel is a physical transmission medium or a logical connection used to transmit at least data in the form of packets over one or more networks. Each channel represents a connection to a network via a respective network interface. In accordance with various disclosed embodiments, the simulated network feedback may be or may include network feedback indicative of network performance experienced via transmission of data over such a channel. In a further embodiment, the simulated network feedback for a given channel includes at least one or more network parameters, where each network parameter has a value indicating network performance with respect to a corresponding network performance metric (e.g., a metric representing a key performance indicator, or KPI).

At S330, network feedback is simulated for each of the identified channels. In an embodiment, the simulation is utilized to determine simulation results including at least simulated network parameters for each of the identified channels. The simulated network parameters may be or may include simulated values which are synthetically generated via simulation, where the simulated values represent values of respective network performance metrics or other network parameters being simulated. In a further embodiment, the simulation results further include data indicating, a simulated timing of the feedback (e.g., a time at which the simulated feedback should be treated as being received), simulated content of the feedback, both, and the like.

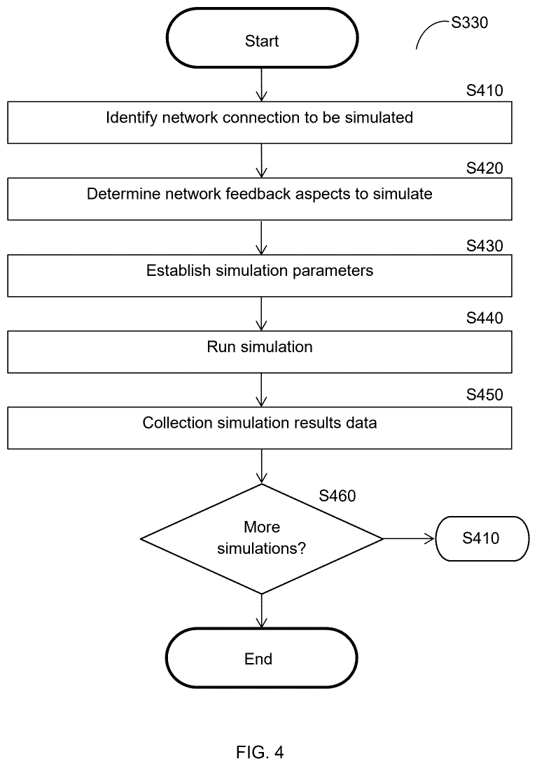

An example process which may be utilized to simulate network feedback for each channel is described further below with respect to FIG. 4.

At S340, simulation results are identified. The simulation results may be collected or otherwise determined based on the outcomes of the simulations.

At S350, at least a portion of the simulation results is injected into a decision-making process. The decision-making process may be, for example but not limited to, a program being executed. Such a program may be realized via instructions that make operational decisions related to a first system acting as a target for operational control (e.g., the target system 120, FIGS. 1A-D). As discussed herein, the decision-making process determines decisions based on network feedback. By injecting the simulation results into the decision-making process, simulated network feedback may effectively be utilized in place of actual feedback, at least temporarily (e.g., until actual feedback is received).

In some embodiments, simulation results are injected into multiple decision-making processes. Different portions of the simulation results may be injected into different decision-making processes, the same portion of the simulation results may be injected into different decision-making processes, or both (i.e., some portions of the simulation results may only be injected into some of the decision-making processes and other portions of the simulation results may be injected into all of the decision-making processes). As a non-limiting example, simulation results based on simulations for a given channel may be injected into one or more respective decision-making processes corresponding to that channel. As noted above, decision-making processes may be organized into tiers. To this end, in yet a further embodiment, the simulation results are injected into the decision-making processes based on the tiers. For example, different portions of the simulation results may be injected into decision-making processes of respective tiers.

At S360, the first system is controlled or caused to be controlled based on the simulation results. More specifically, one or more decisions output by the decision-making process may be utilized to control the target system. In some embodiments, S360 includes controlling the target system, or controlling one or more subsystems of the target system. In another embodiment, S360 includes sending one or more commands or instructions to the first system. When such a command or instructions is executed by the target system, the first system becomes configured to operate according to the decisions determined by the decision-making process.

Steps S370 through S390 are now described for an optional implementation in which the system performing the process of FIG. 3 incorporates the decision-making process (e.g., as depicted in FIG. 1B), integrated in the first system (e.g., as depicted in FIGS. 1C-D), is deployed in-line between the first system and the second system, or deployed so as to intercept communications between the first system and the second system. In other embodiments (not depicted in FIG. 3), steps S370 through S390 may be performed by the system incorporating the decision-making process and may be avoided by the system running the simulations.

At optional S370, network feedback data is received from a second system. More specifically, the second system is a system communicating with the first system such that the first system acts as a target system to be controlled, and the second system acts as a receiving system which receives data from the target system and responds with commands or other data indicating operational actions to be performed by the target system. The second system also returns network feedback, for example, in the form of one or more network parameters such as, but not limited to, jitter, latency, packet loss, combinations thereof, and the like. In this regard, the received network feedback data acts as actual network feedback data determined based on actual network conditions experienced during transit of the data transmitted by the first system to the second system.

At optional S380, the received network feedback is injected into the decision-making process. Such injection of the actual network feedback may be utilized to update the decisions based on the actual network conditions experienced by the data transmitted from the first system to the second system. This allows for using the simulation results until such actual network feedback is received in order to improve decision-making in the meantime.

At optional S390, the first system is controlled or caused to be controlled based on the received network feedback data. More specifically, one or more decisions output by the decision-making process may be utilized to control the target system. In some embodiments, S390 includes controlling the first system, or controlling one or more subsystems of the first system. In another embodiment, S390 includes sending one or more commands or instructions to the first system. When such a command or instructions is executed by the first system, the first system becomes configured to operate according to the decisions determined by the decision-making process.

In some embodiments, the first system is controlled based on both the simulated network feedback data and the received network feedback data. That is, decisions may be determined based on both sets of feedback data, and the first system may be controlled accordingly. In a further embodiment, the first system is controlled based on differences between the simulated and received network feedback data sets, for example, based on a mismatch (e.g., one or more differences in parameters, one or more differences in numerical values above a threshold, etc.) between the simulated and received network feedback data. In yet a further embodiment, the decisions may be determined, the first system may be controlled, or both, based on a type of mismatch between the simulated and received network feedback data.

After S390, execution may continue with S310 when a new simulation trigger (e.g., transmission of new data for which a response is expected or passage of a predetermined amount of time since a last received feedback without receiving new feedback) is detected.

It should be noted that, in any given iteration of the process depicted in FIG. 3, steps S370 through S390 may be optional. That is, in any given iteration, only simulation results may be utilized to control the first system. This may occur, for example, when no feedback is received from the second system, or when feedback is not received from the second system before a certain period of time has passed (e.g., a period of time during which one or more decisions are to be made). In at least some use cases in which decisions are time-sensitive, if no feedback is received or feedback is received too late, decisions may need to be made prior to receiving actual feedback. In such a case, only simulated feedback may be utilized in order to ensure that the system can continue being controlled accordingly even without the actual feedback.

After any given iteration of the process, execution may continue with S310 where a new simulation trigger is detected. The new simulation trigger may be or may include, but is not limited to, transmission of new data, transmission of new data from the same channel which prompted the initial simulation trigger, passage of time (e.g., expiration of a predetermined threshold period of time since the last simulation trigger), combinations thereof, and the like. Execution may continue iteratively proceeding until the target system ceases certain activities which are determined based on network feedback or otherwise stops requiring network feedback.

FIG. 4 is a flowchart S330 illustrating a method for simulating network feedback according to an embodiment.

The process described with respect to FIG. 4 may be utilized to simulate network feedback for a target system (e.g., the target system 120, FIGS. 1A-D) and, in particular, a target system which operates at least partially via instructions or commands received over one or more communication channels. The instructions or commands received by the target system may be accompanied by network feedback during normal operation, and the simulated network feedback may be utilized instead of actual network feedback received via the communication channels, at least temporarily (e.g., until the actual network feedback is received).

At S410, a network connection to be simulated is identified. The network connection may be one of the network conditions currently being utilized by a system which is being at least partially operated based on remote instructions. In an embodiment, the network connection to be simulated is identified based on transmission of data over the network connection. That is, when the network connection is used to transmit data from the system, the transmission may be detected and utilized to identify that simulation of network feedback for the network connection is to begin. More specifically, as noted above, each network connection may be utilized to transmit data over a corresponding channel, and the network feedback simulation for each network connection may be or may include simulated network feedback for the corresponding channel.

At S420, aspects of the network feedback to be simulated are determined. The network feedback aspects to be simulated may be or may include, but are not limited to, values for network performance metrics or other network parameters (e.g., metrics representing key performance indicators for network performance), timing of feedback (i.e., to simulate times at which network feedback data is received), content of feedback (i.e., content of data included in a response to a previous transmission of data for which feedback is expected), combinations thereof, and the like. In an embodiment, the aspects of the network feedback to be simulated at least include values for certain network parameters. The aspects of the feedback to be simulated may be selected in order to effectively simulate the network feedback which would be received during normal operation (e.g., under average or otherwise normal network conditions).

In an embodiment, the aspects of the network feedback to be simulated are determined based on a predetermined set of aspects. Such a predetermined set of aspects may be a predetermined set of aspects to utilize for all simulations, or may be a predetermined set of aspects among multiple predetermined sets of aspects associated with different use cases. That is, the predetermined set of aspects to be simulated may be determined based on the implementation, i.e., which use case the simulations are being applied to. Such use cases may be defined, for example, with respect to type of system being operated (e.g., a vehicle versus a bipedal robot, different types of vehicles such as land-based versus aquatic versus aerial, etc.), specific actions being performed (e.g., for a vehicle, which actions are being performed by the vehicle based on remote operation instructions), both, and the like.

To this end, in a further embodiment, the aspects of the network feedback to be simulated may be determined based further on a type of decision-making process, i.e., a type of the decision-making process for which the simulated network feedback will be injected. As a non-limiting example, the network feedback aspects to be simulated may be different for a decision-making process used by an automobile as contrasted with a decision-making process used by a drone.

In another embodiment, the feedback to be simulated may be determined based on historical network feedback. More specifically, the feedback to be simulated for a given channel may be determined based on historical network feedback for that channel. That is, at least the network feedback parameters to be simulated for the channel may include network feedback parameters which were included in historical feedback data received over that channel. In particular, the network feedback parameters to be simulated may be determined as types of network parameters which are represented in the historical network feedback.

At S430, simulation parameters for the simulation are established. The simulation parameters are established in order to simulate the aspects of the network feedback determined at S420. In some embodiments, the simulation parameters to be established may be selected from among a set of potential simulation parameters. In a further embodiment, the simulation parameters to be established may be determined based on predetermined simulation establishment rules defining predetermined associations between sets of network feedback aspects to be simulated and corresponding sets of simulation parameters to be utilized to run the simulations. In such an embodiment, for a set of network feedback aspects to be simulated in a given simulation, the corresponding set of simulation parameters is used to run the simulation.

In some embodiments, the simulation parameters to be established are determined using machine learning or other artificial intelligence (AI) techniques. More specifically, in such an embodiment, a simulation establishment machine learning model may be applied to features extracted from or otherwise based on the data transmitted for which network feedback is to be simulated, where such a simulation establishment machine learning model is trained to output simulation parameters based on input data transmission features. Such input data transmission features may be or may include features indicating the channel by which data is transmitted, header data or other metadata about the data being transmitted, content of the data transmitted, combinations thereof, and the like.

To this end, the simulation establishment machine learning model may be trained using one or more machine learning techniques such as, but not limited to, unsupervised learning, supervised learning, semi-supervised learning, reinforcement learning, and the like. In a supervised learning implementation, the simulation establishment machine learning model may be trained using sets of training data transmission features and corresponding labels indicating respective sets of training simulation parameters.

In a reinforcement learning implementation, training the simulation establishment machine learning model may include applying the simulation establishment machine learning model to input training data transmission features in order to determine outputs in the form of simulation parameters to be used for running simulations, and running the simulations using the output simulation parameters. In this regard, running the simulations using the output simulation parameters may be utilized as actions, with the result of the simulation being measured via a reward function. The algorithm applied in order to perform such reinforcement learning is configured to iteratively apply the simulation establishment machine learning model and run simulations in order to maximize the value output by the reward function based on different simulations, where the weights of the simulation establishment machine learning model may be modified at each iteration.

In some embodiments, one or more generative AI models may be applied in order to create some or all of the simulation results based on real-time data or historical data. In a further embodiment, time series data may be generated or otherwise estimated based on existing data.

At S440, a simulation is run using the established simulation parameters. The simulation simulates network conditions for a network connection. In an embodiment, outputs of the simulation at least include one or more simulated network parameters. In a further embodiment, outputs of the simulation include simulated timing of network feedback, simulated content of network feedback, both, and the like. The outputs may be included in or otherwise used as simulation results data and injected into one or more decision-making processes in order to make decisions for a target system as described herein.

In an embodiment, running the simulation includes applying one or more simulator machine learning models. That is, in such an embodiment, the simulation may be realized via applying one or more simulator machine learning models instead of or in addition to applying one or more simulation models in order to output at least a portion of the simulation results. Such use of machine learning in combination with or instead of other simulation models may allow, for example, for reducing the computing resources utilized by using machine learning models which are more lightweight (and, consequently, utilize fewer computing resources) than the simulation models. Moreover, machine learning models may be leveraged in order to improve the accuracy of results as compared to at least some simulations.

In another embodiment, one or more running the simulation includes applying one or more generative AI models in order to generate at least a portion of the simulation results (e.g., simulation parameters, simulated content, etc.). In a further embodiment, when simulated content of the network feedback is generated using a generative AI model, the generative AI model may be or may include a large language model (LLM) or other language model trained and configured to generate simulated network feedback content based on previous network feedback content.

At S450, simulation results data is collected for the simulation. As noted above, the simulation results data may be or may include outputs of the simulation such as, but not limited to, simulated network parameters simulated feedback timing, simulated feedback content, combinations thereof, and the like.

At S460, it is checked if more simulations are to be run and, if so, execution continues with S410; otherwise, execution terminates.

In some embodiments, simulations may continue to be run until all network channels to be simulated have been simulated. In this regard, it should be noted that FIG. 4 depicts an implementation in which simulations for different network channels are performed iteratively for simplicity purposes, but that the disclosed embodiments are not limited as such. For example, simulations for multiple network channels may be performed in parallel by performing multiple instances of any or all of the steps S410 through S450 simultaneously or otherwise in parallel.

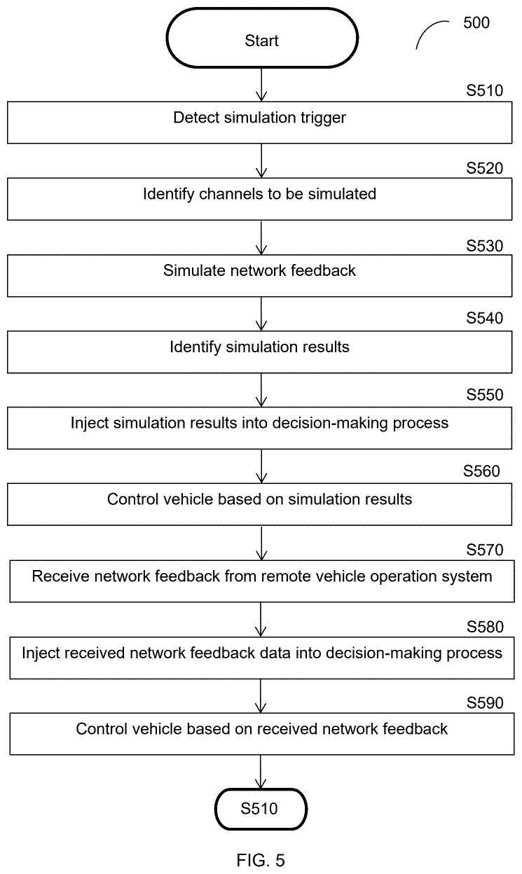

FIG. 5 is a flowchart 500 illustrating a method for operating a vehicle based on simulated network feedback according to an embodiment. In an embodiment, the method is performed by the simulation injector 130, FIGS. 1A-D. In particular, the method may be realized via a deployment such as the implementation shown in FIG. 1D, in which the simulation injector 130 is deployed in a target system 120 deployed in a vehicle 150.

At S510, a simulation trigger is detected. The simulation trigger may be or may include, but is not limited to, transmission of data for which feedback is expected. In some implementations, execution begins when a system begins transmitting data and continues through iterations as long as the system continues transmitting data. At each iteration, the simulation trigger may be the transmission of data over a channel, or the passage of a certain amount of time (e.g., a predetermined amount of time) since a last transmission of data over the channel.

As a non-limiting example for the process using a vehicle as depicted in FIG. 5, the transmission of data by the vehicle which may trigger an initial iteration of the process of FIG. 5 may be or may include data to be used for making remote operation decisions for actions to be performed by the vehicle or to be used for generating supplemental data (e.g., driving assistance data) to aid a driver of the vehicle. Such data may include, but is not limited to, video data (e.g., video data showing an environment around the vehicle), sensor data, both, and the like.

As a further non-limiting example, a remote operator may utilize such vehicle data in order to make decisions about how to steer and accelerate or decelerate the vehicle based on its surroundings. Data returned from a remote system operated by such a remote operator may include commands, instructions, or other data indicating the steering and acceleration/deceleration decisions, as well as network feedback data indicating network conditions experienced during transmission of the vehicle or other sensor data from the vehicle to the remote system.

In some embodiments, transmission of data over different channels may act as the simulation trigger for different instances of the process of FIG. 5. In such an embodiment, different instances of the process may be performed in series or in parallel, with each instance including simulation of network feedback for a respective channel and injection of the simulation results for that channel into a decision-making process (e.g., the decision-making process 121) as feedback for that channel. In a further embodiment, the simulation triggers may be detected for respective channels and be utilized to trigger instances of the process of FIG. 5 for each channel.

In another embodiment, one instance of the process of FIG. 5 may be initially triggered by an initial simulation trigger (e.g., sending of data over one of the channels), and simulations for multiple channels may be performed. That is, when a simulation trigger is detected for any of the channels to trigger a first instance of the process, the process may include simulating network feedback for multiple channels and injecting network feedback simulation results for each of those channels to a decision-making process. Subsequent simulation triggers may include, for example, passage of time. For example, after the initial simulation trigger, iterations of the process including simulating network feedback for the different network channels may be performed periodically, with each iteration being initiated after a certain amount of time has passed.

At S520, network connections for which simulations are to be performed are identified. The network connections may be or may include network connections used by a system (e.g., the target system 120) or a vehicle (e.g., the vehicle 150) to transmit data and, more specifically, network connections for which the system or vehicle would receive feedback from another system to which the data is transmitted (e.g., the remote system 140) during normal operation.

In an embodiment, each network connection may be utilized to transmit data over a corresponding communication channel (also referred to as a “channel”). In a further embodiment, each channel is a physical transmission medium or a logical connection used to transmit at least data in the form of packets over one or more networks. Each channel represents a connection to a network via a respective network interface. In accordance with various disclosed embodiments, the simulated network feedback may be or may include network feedback indicative of network performance experienced via transmission of data over such a channel. In a further embodiment, the simulated network feedback for a given channel includes at least one or more network parameters, where each network parameter has a value indicating network performance with respect to a corresponding network performance metric (e.g., a metric representing a key performance indicator, or KPI).

At S530, network feedback is simulated for each of the identified channels. In an embodiment, the simulation is utilized to determine simulation results including at least simulated network parameters for each of the identified channels. The simulated network parameters may be or may include simulated values which are synthetically generated via simulation, where the simulated values represent values of respective network performance metrics or other network parameters being simulated. In a further embodiment, the simulation results further include data indicating, a simulated timing of the feedback (e.g., a time at which the simulated feedback should be treated as being received), simulated content of the feedback, both, and the like.

An example process which may be utilized to simulate network feedback for each channel is described further above with respect to FIG. 4.

At S540, simulation results are identified. The simulation results may be collected or otherwise determined based on the outcomes of the simulations.

At S550, at least a portion of the simulation results is injected into a decision-making process. The decision-making process may be, for example but not limited to, a program being executed. Such a program may be realized via instructions that make operational decisions related to a first system acting as a target for operational control (e.g., the target system 120, FIGS. 1A-D). As discussed herein, the decision-making process determines decisions based on network feedback. By injecting the simulation results into the decision-making process, simulated network feedback may effectively be utilized in place of actual feedback, at least temporarily (e.g., until actual feedback is received).

At S560, the first system is controlled or caused to be controlled based on the simulation results. More specifically, one or more decisions output by the decision-making process may be utilized to control the target system. In some embodiments, S560 includes controlling the target system, or controlling one or more subsystems of the target system. In another embodiment, S560 includes sending one or more commands or instructions to the first system. When such a command or instructions is executed by the target system, the first system becomes configured to operate according to the decisions determined by the decision-making process.

At optional S570, network feedback data is received from a second system. More specifically, the second system is a system communicating with the first system such that the first system acts as a target system to be controlled, and the second system acts as a receiving system which receives data from the target system and responds with commands or other data indicating operational actions to be performed by the target system. The second system also returns network feedback, for example, in the form of one or more network parameters such as, but not limited to, jitter, latency, packet loss, combinations thereof, and the like. In this regard, the received network feedback data acts as actual network feedback data determined based on actual network conditions experienced during transit of the data transmitted by the first system to the second system.

At optional S580, the received network feedback is injected into the decision-making process. Such injection of the actual network feedback may be utilized to update the decisions based on the actual network conditions experienced by the data transmitted from the first system to the second system. This allows for using the simulation results until such actual network feedback is received in order to improve decision-making in the meantime.

At optional S590, the first system is controlled or caused to be controlled based on the received network feedback data. More specifically, one or more decisions output by the decision-making process may be utilized to control the target system. In some embodiments, S590 includes controlling the first system, or controlling one or more subsystems of the first system. In another embodiment, S590 includes sending one or more commands or instructions to the first system. When such a command or instructions is executed by the first system, the first system becomes configured to operate according to the decisions determined by the decision-making process.

After S590, execution may continue with S510 when a new simulation trigger (e.g., transmission of new data for which a response is expected or passage of a predetermined amount of time since a last received feedback without receiving new feedback) is detected.

It should be noted that, in any given iteration of the process depicted in FIG. 5, steps S570 through S590 may be optional. That is, in any given iteration, only simulation results may be utilized to control the first system. This may occur, for example, when no feedback is received from the second system, or when feedback is not received from the second system before a certain period of time has passed (e.g., a period of time during which one or more decisions are to be made). In at least some use cases in which decisions are time-sensitive, if no feedback is received or feedback is received too late, decisions may need to be made prior to receiving actual feedback. In such a case, only simulated feedback may be utilized in order to ensure that the system can continue being controlled accordingly even without the actual feedback.

After any given iteration of the process, execution may continue with S510 where a new simulation trigger is detected. The new simulation trigger may be or may include, but is not limited to, transmission of new data, transmission of new data from the same channel which prompted the initial simulation trigger, passage of time (e.g., expiration of a predetermined threshold period of time since the last simulation trigger), combinations thereof, and the like. Execution may continue iteratively proceeding until the target system ceases certain activities which are determined based on network feedback or otherwise stops requiring network feedback.

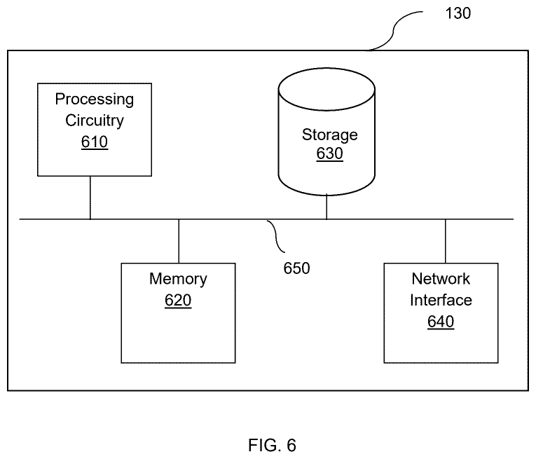

FIG. 6 is an example schematic diagram of a simulation injector 130 according to an embodiment. The simulation injector 130 includes a processing circuitry 610 coupled to a memory 620, a storage 630, and a network interface 640. In an embodiment, the components of the simulation injector 130 may be communicatively connected via a bus 650.

The processing circuitry 610 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 620 may be volatile (e.g., random access memory, etc.), non-volatile (e.g., read only memory, flash memory, etc.), or a combination thereof.

In one configuration, software for implementing one or more embodiments disclosed herein may be stored in the storage 630. In another configuration, the memory 620 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 610, cause the processing circuitry 610 to perform the various processes described herein.

The storage 630 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 640 allows the simulation injector 130 to communicate with other systems, devices, components, applications, or other hardware or software components, for example as described herein.

It should be understood that the embodiments described herein are not limited to the specific architecture illustrated in FIG. 6, and other architectures may be equally used without departing from the scope of the disclosed embodiments.

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various embodiments disclosed herein can be implemented as hardware, firmware, software, or any combination thereof. Moreover, the software may be implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 20; 3A; A and B in combination; B and C in combination; A and C in combination; A, B, and C in combination; 2A and C in combination; A, 3B, and 2C in combination; and the like.

What is claimed is:

1. A method for network feedback simulation injection, comprising:
simulating network feedback for at least one communication channel, wherein the simulated network feedback includes at least one simulated network parameter, each simulated network parameter indicating at least one value of a corresponding network performance metric; and
injecting the simulated network feedback into at least one decision-making process, wherein each decision-making process is configured to determine decisions based on network feedback data.

2. The method of claim 1, wherein each decision-making process is configured to determine decisions for a first system based on the network feedback data, wherein the simulated network feedback is based on a simulation of network performance for network communications between the first system and a second system.

3. The method of claim 2, further comprising:
detecting a simulation trigger including transmission of data from the first system to the second system, wherein the simulation is initiated when the simulation trigger is detected.

4. The method of claim 2, wherein the simulated network feedback is a first set of network feedback, wherein the first system receives a second set of network feedback from the second system, wherein the first set of network feedback is utilized by the at least one decision-making process until the second set of network feedback is received by the first system.

5. The method of claim 4, further comprising:
injecting the second set of network feedback into the at least one decision-making process.

6. The method of claim 1, further comprising:
detecting a simulation trigger based on passage of a predetermined amount of time since a most recent receipt of network feedback, wherein the simulation is initiated when the simulation trigger is detected.

7. The method of claim 1, wherein the simulated network feedback further includes simulated content of the simulated network feedback.

8. The method of claim 1, wherein the simulated network feedback further includes a simulated timing for the simulated network feedback.

9. The method of claim 1, wherein the at least one simulated network parameter is at least a portion of at least one network feedback aspect to be simulated, further comprising:
determining the at least one network feedback aspect to be simulated based on historical network feedback, wherein the at least one simulated network parameter is at least one type of network parameter which is represented in the historical network feedback.

10. The method of claim 9, further comprising:
determining the at least one network feedback aspect to be simulated based further on a decision-making process type for each of the at least one decision-making process.

11. The method of claim 9, further comprising:
establishing at least one simulation parameter based on the determined at least one network feedback aspect to be simulated, wherein establishing the at least one simulation parameter further comprises applying a simulation establishment machine learning model to features extracted from data transmitted by a system.

12. The method of claim 11, wherein simulating the network feedback further comprises:
applying at least one simulator machine learning model to the established at least one simulation parameter, wherein the simulated network feedback is based further on outputs of the at least one simulator machine learning model.

13. The method of claim 1, wherein the at least one communication channel is a plurality of communication channels, wherein simulating the network feedback further comprises:
running a simulation for each of the plurality of communication channels, wherein the simulated network feedback is based on simulation results for the simulation of each of the plurality of communication channels.

14. The method of claim 1, wherein the at least one simulated network parameter includes at least one of latency, jitter, and packet loss.

15. The method of claim 1, further comprising:
determining, using the at least one decision-making process, the decisions for a system based on the simulated network feedback; and
controlling the system based on the determined decisions.

16. The method of claim 15, wherein the system is a vehicle, wherein the determined decisions include driving decisions for the vehicle, wherein controlling the system further comprises driving the vehicle based on the driving decisions.

17. A non-transitory computer readable medium having stored thereon instructions for causing a processing circuitry to execute a process, the process comprising:
simulating network feedback for at least one communication channel, wherein the simulated network feedback includes at least one simulated network parameter, each simulated network parameter indicating at least one value of a corresponding network performance metric; and
injecting the simulated network feedback into at least one decision-making process, wherein the at least one decision-making process is configured to determine decisions based on network feedback data.

18. A system for network feedback simulation injection, comprising:
a processing circuitry; and
a memory, the memory containing instructions that, when executed by the processing circuitry, configure the system to:
simulate network feedback for at least one communication channel, wherein the simulated network feedback includes at least one simulated network parameter, each simulated network parameter indicating at least one value of a corresponding network performance metric; and
inject the simulated network feedback into at least one decision-making process, wherein the at least one decision-making process is configured to determine decisions based on network feedback data.

19. The system of claim 18, wherein the system is a first system, wherein the simulated network feedback is based on a simulation of network performance for network communications between the first system and a second system.

20. The system of claim 19, wherein the system is further configured to:
detect a simulation trigger including transmission of data from the first system to the second system, wherein the simulation is initiated when the simulation trigger is detected.

21. The system of claim 19, wherein the simulated network feedback is a first set of network feedback, wherein the first system receives a second set of network feedback from the second system, wherein the first set of network feedback is utilized by the at least one decision-making process until the second set of network feedback is received by the first system.

22. The system of claim 21, wherein the system is further configured to:
inject the second set of network feedback into the at least one decision-making process.

23. The system of claim 18, wherein the system is further configured to:
detect a simulation trigger based on passage of a predetermined amount of time since a most recent receipt of network feedback, wherein the simulation is initiated when the simulation trigger is detected.

24. The system of claim 18, wherein the simulated network feedback further includes simulated content of the simulated network feedback.

25. The system of claim 18, wherein the simulated network feedback further includes a simulated timing for the simulated network feedback.

26. The system of claim 18, wherein the at least one simulated network parameter is at least a portion of at least one network feedback aspect to be simulated, wherein the system is further configured to:
determine the at least one network feedback aspect to be simulated based on historical network feedback, wherein the at least one simulated network parameter is at least one type of network parameter which is represented in the historical network feedback.

27. The system of claim 26, wherein the system is further configured to:
determine the at least one network feedback aspect to be simulated based further on a decision-making process type of each of the at least one decision-making process.

28. The system of claim 26, wherein the system is further configured to:
establish at least one simulation parameter based on the determined at least one network feedback aspect to be simulated, wherein establishing the at least one simulation parameter further comprises applying a simulation establishment machine learning model to features extracted from data transmitted by the system.

29. The system of claim 28, wherein the system is further configured to:
apply at least one simulator machine learning model to the established at least one simulation parameter, wherein the simulated network feedback is based further on outputs of the at least one simulator machine learning model.

30. The system of claim 18, wherein the at least one communication channel is a plurality of communication channels, wherein the system is further configured to:
run a simulation for each of the plurality of communication channels, wherein the simulated network feedback is based on simulation results for the simulation of each of the plurality of communication channels.

31. The system of claim 18, wherein the at least one simulated network parameter includes at least one of latency, jitter, and packet loss.

32. The system of claim 18, wherein the system is further configured to:
determine, using the at least one decision-making process, the decisions for the system based on the simulated network feedback; and
control the system based on the determined decisions.

33. The system of claim 32, wherein the system is a vehicle, wherein the determined decisions include driving decisions for the vehicle, wherein controlling the system further comprises driving the vehicle based on the driving decisions.
